(19) United States
(12) Patent Application Publication
(10) Pub. No.: US 2002/0147046 A1
(43) Pub. Date: Oct. 10, 2002

(54) Processing method for network game character differentiation and the system thereof

(76) Inventor: Hsin Wang, Taichung (TW)

Correspondence Address: INTELLECTUAL PROPERTY SOLUTIONS, P.L.L.C., Suite 700, 1300 Pennsylvania, N.W., Washington, DC, 20004, US

(21) Appl. No.: 09/897,491

(22) Filed: Jul. 3, 2001

(30) Foreign Application Priority Data
Jul. 13, 2000 (TW) 89113959

(51) Int. Cl. G06F 17/00

(52) U.S. Cl. 463/42

(57) ABSTRACT

A character differentiation system for use with a network game comprises at least one terminal to build up a virtual character in a network game, and at least one server coupled to the terminal that exchanges information with the terminal. The system for differentiating characters in a network game allows players from all terminals to participate by way of a character differentiation process in a collective decision-making protocol.

### BACKGROUND OF THE INVENTION

1. Field of the Invention

The present invention relates to a technique for carrying out a computer game played over a computer network. The present invention especially relates to a processing method for differentiating players participating through different terminals, thus defining their privilege level in a network game so as to provide more diversity and richness as the game proceeds.

2. Description of the Related Art

Most traditional computer games are carried out on a single computer. That is, a client initiates a game on a PC or a gaming host. Usually these are single-player games or double-player games wherein the computer plays the role of the opponent. Other games are capable of accommodating multiple players but are still limited to play on a single hardware system.

As a result of rapid development of networking capabilities and widespread use of the Internet, the number of games utilizing the Internet as a gaming platform to create multiplayer games, such as Ultima Online and many varieties of racing games including car and aircraft racing, is increasing. With no limitations of physical distance, networking offers an ideal platform for such games, and has expanded the computer game market by attracting more consumers.

Conventional network games, however, are often derived from single hardware system games and thus inherit many limitations. For example, all players are treated alike in the game, and all events apply to all players. This limited gaming architecture does not fully utilize the diversity of the involved players, a main feature of network play. Therefore an important task for network game development is to differentiate players participating through different terminals (such as computers or gaming hosts connected to the network) from each other so that gameplay becomes more vivid.

### SUMMARY OF THE INVENTION

The object of the present invention is therefore to provide a processing method and system for differentiating characters in a network game. Characters developed by the players are granted different privileges according to a procedure of collective decision-making, allowing the complexity of gameplay to increase commensurate with player diversity.

Accordingly, the present invention provides a network game operating system capable of differentiating players participating in the network game from each other. The system comprises at least a terminal, and at least a server coupled to the terminal, exchanging information with the terminal. During the character differentiation process, the server formulates a ballot containing characteristics of the involved characters via a registration procedure, and delivers this ballot to all terminals involved in the game. The registration procedure may be a conditioning procedure, that is, a character is included in the ballot automatically as long as the character meets a pre-set registration condition. For example, in the game Monopoly, a character is allowed to declare for candidacy as long as the character remits a given amount of game money (e.g. 15 million game dollars) . Alternatively, an auction procedure can be used with registration such that characters submitting the highest bids are included on the ballot.

Once the ballot is received by an active terminal, the player makes an effective vote for at least one candidate. Voting data from all involved terminals is transmitted to the server, and a winner is determined. The server records the winning character and sends a notice of the election result to each terminal. The winning character is granted first-level privileges in the network game according to preset rules. The winning character can appoint at least one person from the assembled characters to have second-level privileges in the network game. This appointment is also recorded by the server, and related notices are sent to the terminals.

A network game thus becomes more than a merely expanded version of a single-system computer game and more vivid by applying the foregoing character differentiation system.

### BRIEF DESCRIPTION OF THE DRAWINGS

The objects, features, and advantages of the present invention can be better understood by reading the subsequent embodiment and references made to the accompanying drawings, wherein:

FIG. 1 is a schematic diagram of the network game architecture of the embodiment of the present invention.

FIG. 2 is a flow chart showing a client accessing the server through a terminal as described in the embodiment of the present invention.

FIG. 3 is a detailed flow chart for game process after the terminal and server have been connected.

FIG. 4 is a schematic diagram of the recording of personal data for each character in the embodiment.

FIG. 5 is a schematic diagram of the information-processing configuration of the server of the embodiment.

FIG. 6 is a flow chart showing the character differentiation process of the embodiment of the present invention.

FIG. 7 is a processing flow chart of the server during the character differentiation process.

FIG. 8 is a processing flow chart of the terminal during the character differentiation process.

### DETAILED DESCRIPTION OF THE PREFERRED EMBODIMENT

A main purpose of the present embodiment is to describe the process for character differentiation in a network game based on a well-known game, Monopoly. In the present invention, characters in the network game are differentiated through a collective decision-making process; wherein one or more characters in the game are granted specified privilege levels. The characters therefore have different powers from each other so as to enrich the network game. It is to be understood that while Monopoly is used as an example in the present embodiment, it is not intended to limit the scope and application of the present invention. The disclosed method for collective decision-making is fully applicable in many different types of games.

In a conventional Monopoly game, the gameboard is composed of specific locations. A player moves a character to a location according to a counting process such as die-rolling. Depending on the location reached by the character, the character has to deal with different situations, such as buying land, renting, unforeseen setbacks and opportunities, and other scenarios. This conventional single-venue game will now be transferred to operation on a network platform on the present embodiment. The basic architecture is first described.

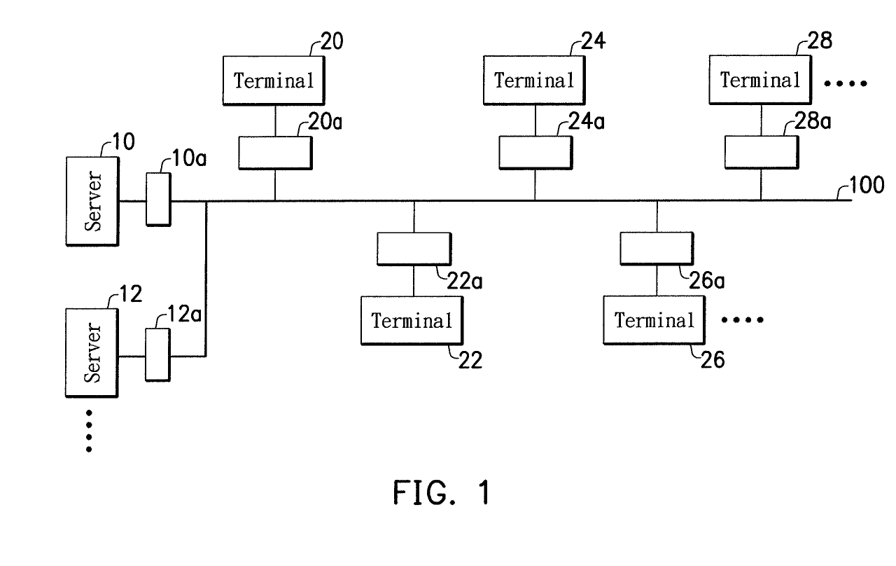

FIG. 1 is a schematic diagram of the network game architecture of the embodiment. As shown in the figure, the network architecture is composed of the clients' terminals 20, 22, 24, 26 and 28 and server systems 10, and 12. The number of involved terminals and servers changes depending on the gaming environment. The terminals and servers are connected via a network 100. Terminals 20, 22, 24, 26, and 28 are connected to network 100 via corresponding network devices 20a, 22a, 24a, 26a and 28a. Servers 10 and 12 are connected to network 100 via corresponding network devices (10a, 12a). Network 100 nay be a local area network (LAN), the Internet, or combination of both. The type of network device varies according to the operating environment. Examples of different types of network device are, network interface card (NIC) or various Internet Protocol (IP) modem connections such as dial-up, DSL or Cable modem, and others. Technology relating to hardware architecture and protocols described herein is well known and thus will not be described in detail in the specification.

Terminals 20, 22, 24, 26, and 28 are installed with a client terminal program for carrying out the network game. This client terminal program, for example, may be installed from the gaming package bought by players. In the present embodiment, the gaming package encloses a set of identification elements (ID) allowing the player to create a character based on individual preferences on servers 10 and 12 at the initial login. Servers 10 and 12 store basic information (which will be subsequently described) for each character, and as the game proceeds, exchange information with the involved terminals.

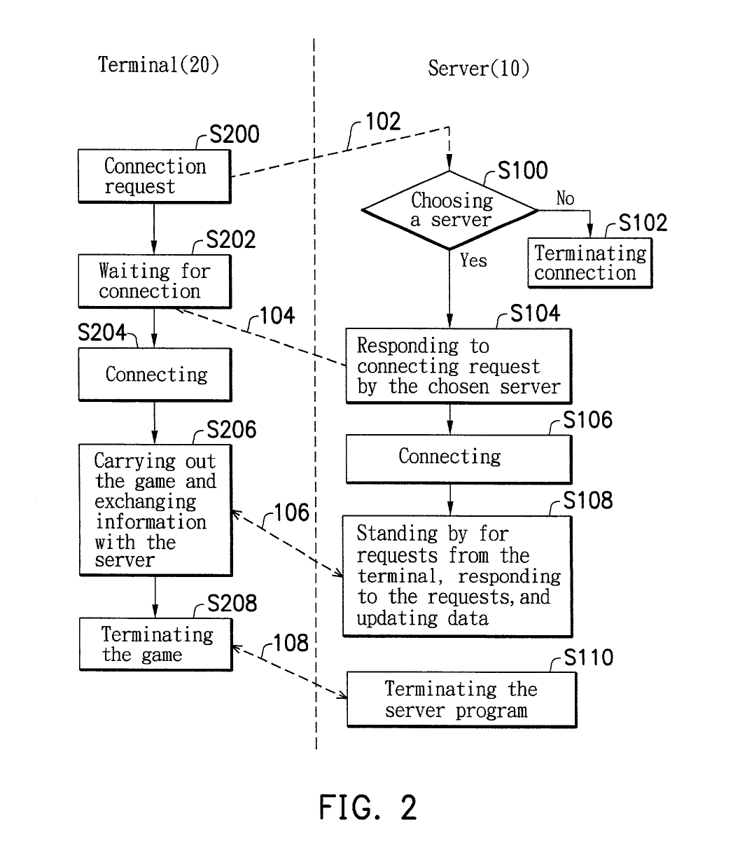

FIG. 2 is a flow chart showing a client accessing the server through a terminal as described in the embodiment. While terminal 20 is used as an example, this process is also suitable for other terminals. First, a connection request 102 (Step S200) is sent when the client terminal program is carried out. The program then waits for connection (Step S202). When this connection request 102 is transmitted through network 100 and received at the server, a suitable server system is then chosen according to loading capacity and other conditions (Step S100). In order to maintain the quality of online service, the connection request will be turned off when no server is suitable for the job (Step S102). A server will, however, be chosen under normal circumstances. For the purposes of this description, server 10 is assumed to be the chosen server. Server 10 then sends a response 104 to terminal 20 (Step S104), and a connection between server 10 and terminal 20 is established (Steps S204 and S106). After the connection has been established, the game proceeds at terminal 20 according to the program and terminal 20 exchanges information 106 with server 10 as needed. At the same time, server 10 receives requests form terminal 20 and responds, and saves information relating to the character (Step S108). When the client decides to end the game (Step S208) and sends out a disconnection request 108, server 10 terminates the server program (Step S110) and ends the connection. It is to be noted that what is shown in FIG. 2 is a termination under normal circumstances. When terminal 20 is accidentally disconnected, server 10 can end the server program once terminal 20 has been set aside for a certain period.

When the connection has been established, terminal 20 carries out the game in Step S206. At the same time, server 10 exchanges information with terminal 20 and updates information relating to the character in coordination with the proceeding game.

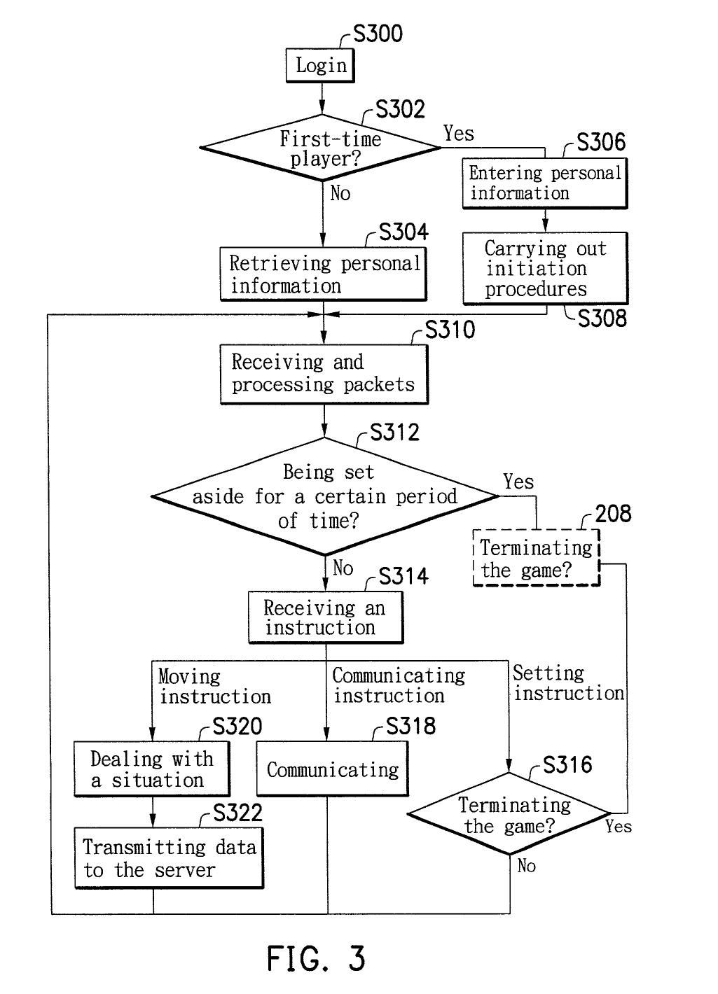

FIG. 3 is a detailed flow chart for game process after the terminal and server have been connected. Server 10 requests client login (Step S300). That is, a message requesting an identifier (and pre-set password) is shown on the monitor of terminal 20. A first-time player (Step S302), inputs the identifier included with the gaming package, and server 10 then requests the player's basic character information (Step S306) such as name, gender, and other information. This character then undergoes initiation procedures (Step S308), such as setting the starting amount of game money and initial location of the character. The personal information of the character is recorded on server 10. In the case of an experienced player who has developed a corresponding character, terminal 20 retrieves personal information of the character from server 10 (Step S304).

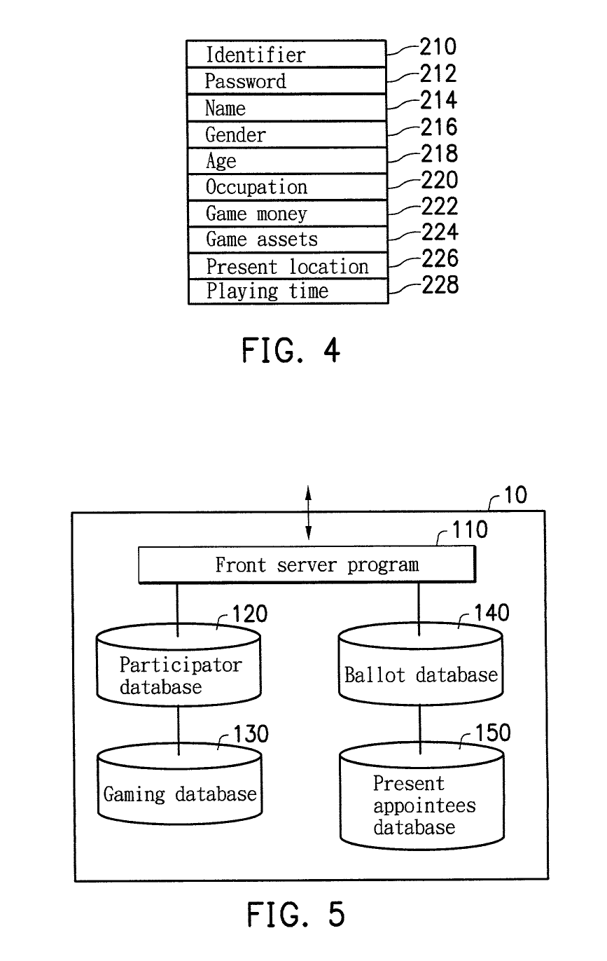

FIG. 4 is a schematic diagram for recording personal data of each character in the embodiment. For each character, personal information (200) includes identifier 210, login password 212, name 214, gender 216, age 218, occupation 220, game money 222, game assets 224, present location 226, and playing time 228. The purpose of the identifier 210 and login password 212 is to identify the status of the person logged in, and as previously described, identifier 210 is included in the gaming package bought by the client and allows the player to access the network game. Password 212 may be set by the player at the first time login, or otherwise came with the identifier 210. Password 212 can be changed by the player when connecting to the server. Name 214 and gender 216 are entered by the player when the character is developed. Age 218, game money 222, game assets 224, present location 226, and playing time 228 are set by server 10 at initiation of the character, and vary as the game proceeds. In the present embodiment, features of the character are defined based on occupation 220. Different occupations are assigned to involved characters through a collective decision-making process. These occupations include “common people” (occupational value 00) having ordinary jobs; “president” (occupational value 99), who is exempted from all fines, taxes, and penalties; and “ministers” of various departments entitled with various privilege such as “Domestic Minister” (occupational value 88) with privilege over purchasing land, “Defense Minister” (occupational value 77) with conscription power, and other ministers. In the present embodiment, only the “president” is elected via collective decision, and the “ministers” are appointed by the “president”. Procedure for election and appointment will be subsequently described. Moreover, items for personal information of involved characters as described previously can vary depending on different game configuration.

Referring to FIG. 3, after terminal 20 retrieves the personal information of the character, the terminal receives and processes packets as the game proceeds (Step S310). During this process, if game operation is set aside for a certain period of time (e.g., 30 minutes) (Step S312), a disconnection request will be sent from terminal 20 to automatically discontinue the game. Under normal operation, the client-side program at terminal 20 receives and carries out instructions from the player. Upon the player's moving instructions, the character makes its move according to a die toss, and performs the functions encountered upon reaching the turn's destination, such as buying land, paying tax, or other events (Step 320). When the action is complete, terminal 20 transmits the information to server 10 (Step S322), and returns to Step S310. The player also has the option to communicate with other terminals and servers through a communication instruction (Step S318). A instruction for disconnection is also available (Step S316). Thus, the network game proceeds according to instructions from players from different terminals.

Before explaining the procedure for the collective decision-making process of the present embodiment, the information processing configuration of server 10 is described: FIG. 5 is a schematic diagram showing the information processing configuration of the server in the embodiment. As shown in FIG. 5, server 10 contains a front server program 110, which processes information exchanged with the terminals. Among the exchanged information is the basic personal information of each character and information of each character's relation with other characters sent by server 10 to the terminals, as well as information relating to the characters sent by the terminals to server 10. A number of databases for storing information required to carry out the game are also provided by server 10. Participator database 120 storing information of individuals who have registered, gaming database 130 storing basic information of the Monoploy game, ballot database 140 storing process of collective decision, and present appointees database 150 storing information for the present appointees for special positions. It should be noted that participator database 120 contains basic personal information for each character, such as that shown in FIG. 4. Personal information stored in participator database 120 is updated as the game proceeds. Present appointee database 150 can be developed based on participator database 120 so that terminals can retrieve the information more easily.

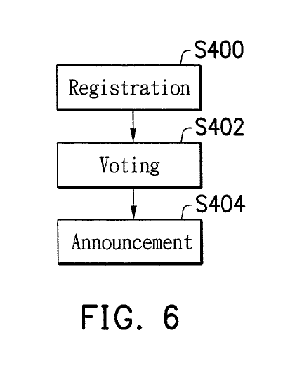

FIG. 6 is a flow chart for the character differentiation process of the embodiment of the present invention. The procedure comprises three main steps, namely registration (Step S400), voting (Step S402), and announcement (Step S404). In the present embodiment, an election is held periodically at designated times. For example, an election can be set so that registration ends at 8 pm and the voting ends at 9 pm on Tuesday, Thursday, or Saturday.

Registration S400 allows the server to select a plurality of candidates from the characters according to a pre-set registration procedure, and sends the ballot to each terminal. In the present embodiment, the registration procedure may be a set of conditions, an auction, or others. When a set of conditions is used, the server includes a character in the ballot automatically when the character meets the pre-set condition(s) for registration. This condition for registration, for example, can be a payment of a certain amount of game money. In an auction procedure, the system determines registration priority based on bid information entered by the players for their corresponding characters, and includes a plurality (such as 6) of characters with the highest priority in the ballot. An example of auction procedure is described as follow.

Voting step S402 allows operators of involved terminals to vote according to the ballot and generate voting data. Voting data herein states for at least an effective vote from one character. The number of votes each character can give varies for different games and situations. As for the preset embodiment, each character is allowed to vote for one candidate. After receiving the voting data from the terminals, the server determines a winner, which is granted with the position of “president” in the present embodiment.

Announcement S404 involves the recording of the election result and transmitting appropriate messages to involved terminals by the server. According to preset rules, the elected “president” is granted certain privilege including various exemptions and the power to appoint the “ministers” in the gaming scenario. Likewise, characters appointed as the “ministers” are granted various privileges. Messages relating to the appointments are also transmitted to each terminal by the server.

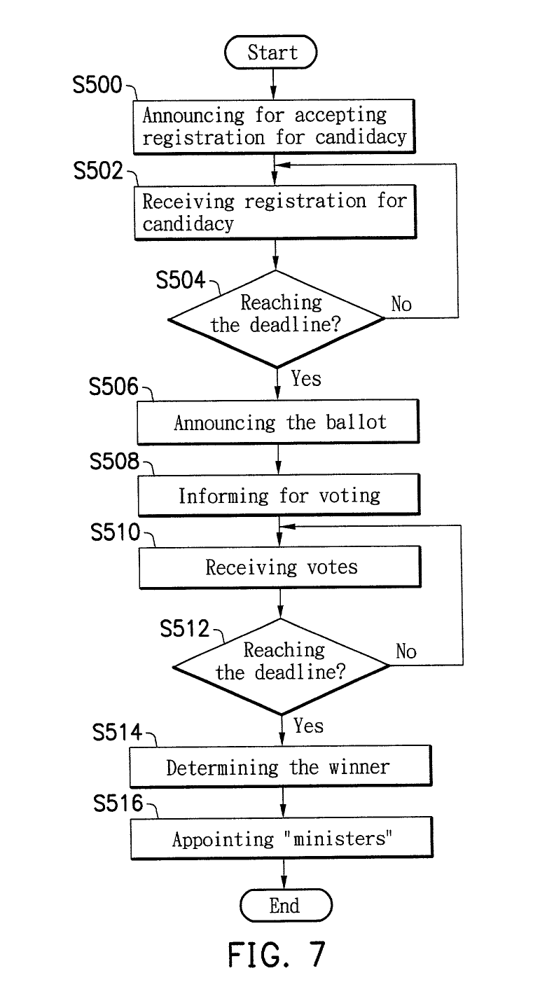

FIG. 7 is a processing flow chart for the server during the character differentiation process. As shown in FIG. 7, server 10 sends out an announcement accepting registration for candidacy (Step S500) at a certain time point before the registration is closed (such as 8 pm on Tuesday, Thursday, or Saturday). The announcement may be a post on a bulletin board set up in the server, or a message transmitted to all involved players via an inner communication instruction, e-mail, or other communicating channels.

After the announcement, the server receives registration from the characters (Step S502) and closes the process at the deadline. In the present embodiment, the deadline is set to 9 am on the same day. As previously stated, the registration system may be a set of conditions. Next, the server determines the ballot according to the pre-set registration system and announces the ballot (Step S504) allowing players who have joined the registration to check whether their registration has been accepted.

The server sends the ballot and a voting notice to the involved terminals (Step S508). It is to be noted that while the voting notice is addressed to every involved terminal in the present embodiment, this is not necessary in actual application. For example, the server can selectively send the voting notice to characters with the right to vote, which is in turn determined by the status of the characters such as age, gender, or wealth. Another example is to ask all players to vote on a designated voting page. Players place their vote after receiving the voting notice, and send the voting data to the server (step S510). The voting process is terminated at the deadline (Step S512). In present embodiment, the deadline is 9 pm on the voting day.

When the voting process is complete, the server determines the winner based on the votes received by each candidate (Step S514). Participator database 120 and present appointee database 150 in the server are updated according to the election results. Personal information stored in the elected character's corresponding terminal is also updated. The elected character can thus execute his/her privilege in the follow-up game. A notice of the election result is also sent to on-line terminals by the server. At this stage, the “president elect” appoints “ministers” for the Departments (Step S516), and the server updates the databases as well as the personal information of appointed characters stored in corresponding terminals according to the appointments. The election is thus concluded.

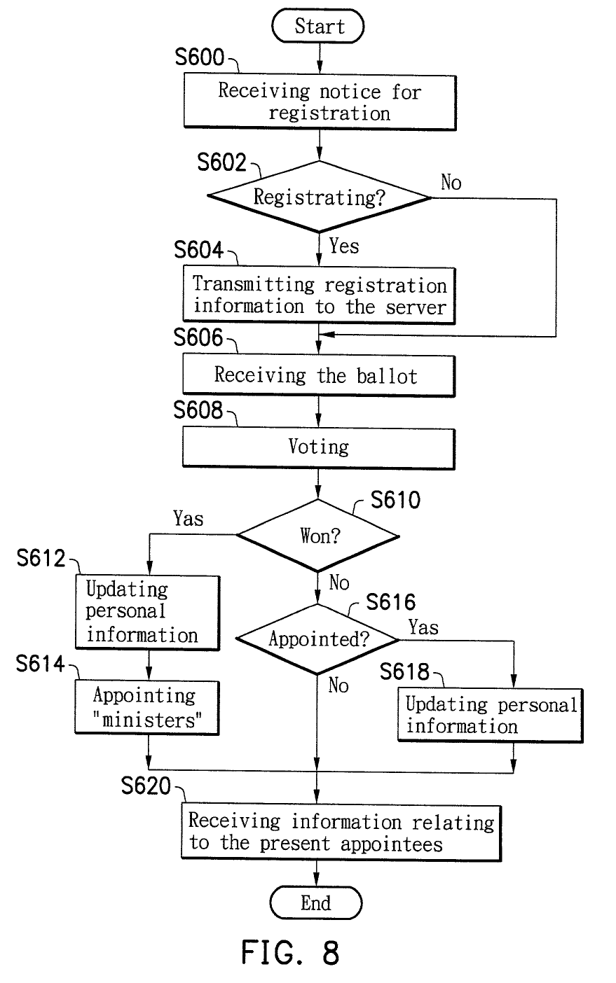

FIG. 8 is a processing flow chart for the terminal during the character differentiation process. What is shown herein is a general character differentiation procedure for the server. It is to be noted that some steps in the procedure can be adjusted according to the gaming conditions. For example, steps applied to the winner are not applicable to a character that does not run for the presidency.

Steps in FIG. 8 are described in detail as follows. As shown in FIG. 8, the terminal receives a notice for registration for candidacy (Step S600). If the player chooses to run for the presidency (Step S602), registration information is sent to the server (Step S604). The registration information may be a game money-based entry fee as defined in a set of conditions, or a bid in an auction process. The terminal receives a ballot from the server after the registration is closed (Step S606). The player then votes via an input device on the terminal to generate a countable vote, which is transmitted to the server (Step S608).

For the terminal with the corresponding character elected as “president” (Step S610), the personal information of the character stored in the terminal is updated (Step S612), and procedure for appointing “ministers” will be carried out (Step S614). For the terminal with a corresponding character who did not win the election but is appointed “minister” (Step S616), personal information of the character is also updated (Step S618). Finally, the terminal receives information relating to the results of the election and appointments, and concludes the election.

The present embodiment allows every player to take a part in the allotment of privileges. Compared with the prior art, the present invention provides gameplay with more complexity and richness, resulting in increased player interest.

The foregoing descriptions of preferred embodiment of the present invention have been presented for purposes of illustration and description. They are not intended to be exhaustive or to limit the invention to the precise forms disclosed, and obviously many modifications and variations are possible in light of the above teaching. It is intended that the scope of the invention be defined by the Claims appended hereto and their equivalents.

What is claimed is:

1. A system for carrying out character differentiation in a network game, the system comprising:
at least one terminal, for developing a character in the network game; and
at least one server coupled to the terminal and for exchanging information with the terminal;
wherein the server determines a ballot via a preset procedure and transmits the ballot to the coupled terminal, the ballot contains at least one character developed by the coupled terminal;
wherein the terminal generates at least one countable vote and transmits the voting data to the server; and
wherein the server determines a winner from characters listed in the ballot according to the voting data received, and records the winner as having first-level privileges.

2. The system as set forth in claim 1, further comprising at least an appointment of a character issued from the terminal corresponding to the winner, wherein the appointment is transmitted to the server and the appointed character is recorded as having second-level privileges.

3. The system as set forth in claim 1, wherein the preset procedure includes a character in the ballot as long as the character meets a preset condition for registration.

4. The system as set forth in claim 1, wherein the preset procedure determines whether to includes a character in the ballot according to a priority of the character.

5. The system as set forth in claim 1, wherein the server transmits information relates to the winner to the terminal.

6. The system as set forth in claim 2, wherein the server transmits information relating to the winner and appointed character to the terminal.

7. A server connected to at least one terminal for carrying out a network game, wherein a character in the network game is developed through the terminal.
wherein the server determines a ballot via a preset procedure and transmits the ballot to the coupled terminal, the ballot contains at least one character developed by the coupled terminal; and
wherein the server receives voting data transmitted from the terminal and determines a winner from characters listed in the ballot according to the voting data received, and records the winner as having first-level privileges, wherein the voting data comprises at least one vote for a character listed in the ballot.

8. The server as set forth in claim 7, further receiving at least one appointment of a character issued from the terminal corresponding to the winner, and recording the appointed character as having second-level privileges.

9. The server as set forth in claim 7, wherein the preset procedure includes a character in the ballot as long as the character meets preset conditions for registration.

10. The server as set forth in claim 7, wherein the preset procedure determines whether to include a character in the ballot according to a priority of the character.

11. The server as set forth in claim 7, wherein the server transmits information relating to the winner to the terminal.

12. The server as set forth in claim 8, wherein the server transmits information relating to the winner and appointed character to the terminal.

13. A character differentiation method for carrying out a network game, wherein the network game contains characters developed through terminals coupled to a server, the character differentiation method comprising the steps of:
determining a ballot containing characters selected by a preset procedure, wherein the characters are selected from those characters developed by the terminals;
transmitting the ballot to the terminals;
generating at least one voting data according to the ballot, wherein the voting data contains at least one vote for a character listed on the ballot;
transmitting the voting data to the server;
determining a winner according to the voting data; and
recording the winner as having first-level privileges in the server.

14. The method as set forth in claim 13, further comprising steps of:
appointing at least a character through the terminal corresponding to the winner, wherein the appointed character is granted second-level privileges in the network game; and
transmitting information relating to the appointed character to the server.

15. The method as set forth in claim 13, wherein the preset procedure includes a character in the ballot as long as the character meets preset conditions for registration.

16. The method as set forth in claim 13, wherein the preset procedure determines whether to include a character in the ballot according to a priority of the character.

17. The method as set forth in claim 13, further comprising the step of:
transmitting information relating to the winner to the terminals.

18. The method as set forth in claim 14, further comprising the step of:
transmitting information relating to the winner and appointed character to the terminals.

19. A character differentiation method for a server to carry out a network game, wherein characters of the network game are developed through terminals coupled to the server, the character differentiation method comprising the steps of:
determining a ballot containing characters selected by a preset procedure, wherein the characters are selected from those characters developed through the terminals;
transmitting the ballot to the terminals;
receiving at least one countable vote according to the ballot from the terminals, wherein the voting data contains at least one vote for a character listed on the ballot;
determining a winner according to the voting data; and
recording the winner as having first-level privileges in the server.

20. The method as set forth in claim 19, further comprising steps of:
receiving information relating to an appointed character from the terminal corresponding to the winner, wherein the appointed character is granted with second-level privileges in the network game.

21. The method as set forth in claim 19, wherein the preset procedure includes a character in the ballot as long as the character meets preset conditions for registration.

22. The method as set forth in claim 19, wherein the preset procedure determines whether to includes a character in the ballot according to a priority of the character.

23. The method as set forth in claim 19, further comprising the step of:
transmitting information relating to the winner to the terminals.

24. The method as set forth in claim 20, further comprising the step of:
transmitting information relating to the winner and appointed character to the terminals.

25. A character differentiation method for a terminal to carry out a network game, wherein the terminal is coupled to a server, the character differentiation method comprising the steps of:
receiving a ballot from the server, wherein the ballot contains a plurality of characters in the network game;
generating at least one countable vote according to the ballot from the terminals via an input device, wherein the voting data contains at least one vote for a character listed on the ballot;
receiving information relating to the winner from the server, wherein the winner is one of the characters included in the ballot; and
recording the winner as having first-level privileges in the network game.

26. The method as set forth in claim 25, further comprising steps of:
receiving information relating to an appointed character from the terminal corresponding to the winner;
recording the appointed character as having a second-level privileges in the network game.

27. The method as set forth in claim 25, further comprising steps of:
receiving a registration notice from the server;
transmitting registration information relating to the corresponding character to the server.

28. The method as set forth in claim 25, further comprising the step of:
if the winner corresponds to the terminal, appointing an appointee from characters in the network game; and
transmitting information relating to the appointee to the server, wherein the appointee is granted with a second-level privilege in the network game.
